(19) United States
(12) Patent Application Publication
(10) Pub. No.: US 2004/0191524 A1
(43) Pub. Date: Sep. 30, 2004

(54) Decoration methods

(76) Inventor: James Anthony Lodge, Milton Keyes (GB)

Correspondence Address: Galgano & Burke, 300 Rabro Drive, Suite 135, Hauppauge, NY, 11788, US

(21) Appl. No.: 10/779,111

(22) Filed: Feb. 13, 2004

Related U.S. Application Data
(63) Continuation-in-part of application No. 10/745,138, filed on Dec. 23, 2003.
Application No. 10/745,138 is a continuation of application No. 10/078,024, filed on Feb. 15, 2002, now Pat. No. 6,759,099.
Application No. 10/078,024 is a continuation of application No. 09/194,714, filed on Apr. 22, 1999, now abandoned.

(30) Foreign Application Priority Data
Jun. 17, 1998 (WO) PCT/GB98/01778

(51) Int. Cl. B05D 1/18; B32B 27/38

(52) U.S. Cl. 428/417; 427/402; 427/430.1; 428/413

(57) ABSTRACT

A method of decorating a ceramic article, includes the steps of mixing a thermochromic pigment with a first coating material to form a first coating mixture, applying the first coating mixture directly onto a part or substantially the whole outer surface of the tableware article and, once the first coating mixture is cured, applying a second coating material over the first coating mixture, the second coating material being substantially dishwasher proof.

This application is a continuation-in-part application of co-pending U.S. application Ser. No. 10/745,138, filed Dec. 23, 2003, which is a continuation of co-pending U.S. application Ser. No. 10/078,024, filed Feb. 15, 2002, which is a continuation of U.S. application Ser. No. 09/194,714, filed Apr. 22, 1999, now abandoned.

### FIELD OF THE INVENTION

This invention concerns a decoration method and particularly but not exclusively a decoration method usable on products such as items of tableware.

### BACKGROUND TO THE INVENTION

Presently a wide range of decoration methods and techniques are applied to items such as tableware, e.g. cups, plates, teapots, glasses etc. It is desirable to produce new effects in such decoration. It is also generally a requirement that such decorations should be durable and also dishwasher proof.

Thermochromic pigments are materials which at a specified temperature change colour, or become transparent or at least translucent.

Thermochromic and photochromic encapsulated dyes were developed a number of years ago, and primarily incorporated into plastic or textile colourants for wide commercial applications (e.g. the “mood ring” and thermochromic dyes clothing). Thermochromic dyes go through a colour change over a specific temperature range. The dyes currently available change from a particular colour at low temperature to colourless at a high temperature or vice versa (e.g. red at 85° Fahrenheit and colourless at above 90° Fahrenheit). The colour change temperature can be controlled, such that the colour-change can take place at different temperatures (e.g. just below a person's external body temperature so that a colour change occurs in response to a human touch). The thermochromic dye manufacturers are able to manipulate the critical temperature for the colour change.

The variability in the dyes is a result of the process used in their manufacture. One technique used to produce the thermochromic encapsulated dye is to combine water, dye, oil, and melamine formaldehyde and shake to create a very fine emulsification. Because of the properties of the compounds, the oil and dye end up on the inside of the capsule and the water ends up on the outside, with the melamine formaldehyde making up the capsule itself. The encapsulation, melamine formaldehyde, is a thermo set resin similar to formica. The substance is very hard and will not beak down at high temperature. It is almost entirely insoluble in most solvents, but it is permeable.

Thermochromic pigments are commercially available from a number of suppliers, such as the Pilot Ink Company Limited of Japan. These pigments can be supplied pre-formulated in a number of different ways. They are commonly sold as inks, paints, or pre-incorporated into plastics materials. Thermochromic inks may be used in a veriety of printing processes such as off-set or screen printing, whereas paints can be used to create surface decorations by brush or spray application onto substrates such as metal to which inks generally do not adhere.

Thermochromic, or colour-change decoration, is becoming increasingly popular and has considerable application in the promotional gift sector. By its very nature, this demands continual innovation to provide new and ever more impressive items to catch the eye of the purchaser and the receiver of the gift.

It is an object of the present invention to teach improved decoration methods for the decoration of tableware items.

### SUMMARY OF THE INVENTION

According to the present invention there is provided a method of decorating a ceramic article, said method comprising the steps of:

a) mixing a thermochromic pigment with a first coating material to form a first coating mixture;

b) applying the first coating mixture directly onto a part or substantially the whole outer surface of the tableware article;

c) once the first coating mixture is cured, applying a second coating material over the first coating mixture;

wherein the second coating material is substantially dishwasher proof.

The present method provides an attractive, durable thermochromic decorated article.

Preferably the first coating mixture is applied to the ceramic article by a dipping process. The ability to use a dipping technique, as opposed to spraying, reduces the cost of working the method considerably. No expensive spray booths or expensive spraying equipment is required.

Preferably the second coating material is applied by a dipping process.

In a particularly preferred embodiment both the first coating mixture and the second coating material are applied by a dipping process.

Preferably the ceramic article is pre-heated immediately prior to the dipping stage. This causes the coating mixture to adhere to the surface of the article and helps prevent runs forming.

Preferably the ceramic article is pre-heated to a temperature in the range 50° to 220° C.

Advantageously the ceramic article is pre-heated to a temperature in the range 70° to 120° C.

Preferably the first coating mixture further comprises an adhesion promoter. This again helps bond the coating mixture to the surface of the article. An adhesion promoter can be used as well as a pre-heating stage or instead of pre-heating.

Preferably the proportion of adhesion promoter in the first coating mixture is within the range 0.1% to 10% by weight, and more preferably in the range of 1.5% to 5% by weight.

Advantageously the ceramic article is an article of glassware. It was not previously recognised that such a process could be applied to glassware.

In an alternative preferred embodiment the ceramic article is an article of glazed tableware.

Preferably the first coating material is substantially transparent.

Preferably the second coating material is substantially transparent.

In a particularly preferred embodiment the first and/or second coating materials comprise lacquers.

Preferably the first coating material comprises a water based lacquer.

Preferably the second coating material comprises a two-part epoxy fortified acrylic resin, including an activator and a thinner.

Preferably the thermochromic pigment comprises a thermochromic ink.

Preferably the proportion of thermochromic pigment in the mixture is within the range 5% to 35% by weight.

Preferably the first coating mixture and/or second coating material are cured following application onto the article.

Preferably the curing commences with a period in an infra-red shortwave drier followed by a heat cure.

Preferably the curing includes a heat cure comprising a lower temperature first period, followed by a higher temperature second period.

Preferably for the first coating mixture, the first period lasts between one and two minutes at 35° C. to 65° C., with the second period lasting eight to twelve minutes at 140° C. to 220° C.

Preferably for the second coating material the first period lasts between eight and twelve minutes at 35° C. to 65° C., with the second period lasting twenty five to thirty minutes at 110° C. to 165° C.

In one embodiment a decoration is provided on the article beneath the mixture such that when the thermochromic ink is at least translucent, said decoration is visible.

Preferably the first coating mixture comprises a plurality of thermochromic inks with different colour change temperatures and advantageously the inks are different colours.

Preferably the said second coating material is applied to the article by spraying.

In an alternative embodiment the first coating mixture and/or second coating material are applied to the article by electrostatic spraying and an electrostatic thinner is added to the mixture and/or second coating prior to spraying.

Preferably the first coating mixture and the second coating material are applied to a thickness of between 12 and 24 microns.

Preferably an electrostatic thinner is added to at least one of said first coating mixture and said second coating material prior to spraying.

In a particularly preferred embodiment said method comprises a further step whereby a decoration is applied onto the second coating material, once cured, by means of a dye sublimation process.

The present invention also extends to an article decorated according to any of the methods described herein.

### DESCRIPTION OF THE PREFERRED EMBODIMENT

Embodiments of the present invention will now be described by way of example only. These examples are the best ways currently known to the applicant of putting the invention into practice, but they are not the only ways in which this could be achieved.

A ceramic teapot is formed, decorated and glazed in a conventional manner so as to have a pattern such as a series of fruit on it. A thermochromic outer layer is then applied as follows:

A dark blue thermochromic ink is mixed with an organic water-based lacquer with 5% to 25% of the ink, dependent on the strength of colour required. An electrostatic thinner is added to the mixture which is then applied by electrostatic spraying using an RD-3000 Turbodisc system. The mixture is sprayed to provide a 20 micron layer.

This layer is then cured by an initial pass through an infra-red shortwave drier and then a subsequent pass through a gas convention drier or driers with an initial first stage of one to two minutes at 35° to 65° C., and a second stage lasting eight to twelve minutes at 140° to 220° C.

A transparent outer coating is then applied to the teapot as follows:

A two-part epoxy fortified acrylic resin is mixed together and applied by electrostatic spraying in a similar manner to the first layer outlined above. This second layer is then cured again with a first pass through a shortwave infra-red drier and then subsequently passes through a gas convection drier initially for eight to twelve minutes at 35° to 65° C., and then twenty five to thirty minutes at 110° to 165° C.

The finished product has a durable glossy finish which is substantially dishwasher proof. At room temperature the teapot is dark blue. When boiling water is added the thermochromic ink changes to a substantially transparent state such that the fruit pattern beneath the thermochromic coating can be clearly seen. As the teapot subsequently cools, the dark blue colouring will return to again obscure the fruit pattern.

There is thus described a decoration method which permits items such as tableware to be readily decorated in a relatively straightforward manner with a novel decoration. In view of the good finish provided by the decoration and the fact that it is substantially dishwasher proof, the decoration does not detract from the product and provides considerable enhancement with the decoration.

It is to be realised that a wide range of decorations can be provided using a method according to the present invention, to provide, for example, decorations which appear or disappear at below or above room temperature. These decorations can selectively obscure decorations, messages etc. therebeneath. It is possible for a plurality of different thermachromes with different colour change temperatures and perhaps also different colours to be mixed, such that a decoration can pass from one colour perhaps to reveal a pattern or decoration therebeneath, and subsequently to move to a further colour as the temperature rises or falls. A wide range of colours can be used as is available.

By way of example only, a coating material suitable for the first coating material is CERAGLAZE™ SW1477 thermosetting water based polyurethane ceramic coating, supplied by Neogene Paints Ltd of Watford, England, and designed to give a high gloss, chemical resistant finish to ceramic-based articles. CERAGLAZE™ SW1477 is designed to be applied by both conventional spray and electrostatic disc equipment.

### EXAMPLE 1

### Mixing Ratio for First Coating Material

| | % by weight |
|---|---|
| SW1477 clear lacquer | 66 |
| Aqueous thermochromic pigment | 29 |
| M1478 adhesion promoter | 1.9 |
| Water | 3.1 |
| | 100% |

Water may be added to obtain a spray application viscosity of 20 to 25 seconds measured on a DIN4 Flow Cup at 25° C.

Curing time is typically 8 minutes at 220° C. in a convection oven.

By way of further example, a coating material suitable for the second coating material is CERAGLAZE™ SA1543G clear lacquer, supplied by Neogene Paints Ltd of Watford, England. CERAGLAZE™ SA1543 is a high performance two-component protective clear coating designed to give a tough chemical and abrasion resistant finish to ceramic based articles. CERAGLAZE™ SA1543 distinguishes itself by its high volume solids at application, resulting in a high degree of gloss and image clarity. The highly modified polymer system in combination with aliphatic polyisocyanate SA1490 Hardener produces a coating film of unrivalled chemical and water resistance. Inclusion of M1492 Adhesion Promoter provides dishwasher and boiling water resistance.

### EXAMPLE 2

### Mixing Ratio for Second Coating Material

| | % by weight |
|---|---|
| SA1543G clear lacquer | 58 |
| SA1490 hardener | 20 |
| M1491 thinner | 13 |
| M1517 thinner | 7 |
| M1492 adhesion promoter | 2 |
| | 100% |

The lacquer, hardener and thinner(s) are mixed well before adding the adhesion promoter. Viscosity should be 14 to 16 seconds measured on a DIN4 Flow Cup at 25° C.

This second coating material has the advantage that it also acts as a sublimation lacquer, enabling designs to be added directly to the outside surface of the mug after the thermochromic finish has been applied and set. Where the thermochromic colour is a relatively dark colour, such as dark blue, dark green or black, the design applied by sublimation becomes virtually invisible. However, the design becomes fully visible once the thermochromic pigment undergoes a colour change from coloured to clear. Typically this takes place by adding warm or cold material to the tableware item. In the case of a mug or a glass, this would result from adding a hot beverage or an ice-cold beverage, as determined by the designer.

A preferred method of applying the first and second coating materials to a piece of ceramic tableware is by spraying, and more preferably by electrostatic spraying. However, we have unexpectedly discovered that these coating materials may also be applied by dipping. Whilst dipping is a technique which has been used to apply glaze to the surface of an unglazed item, it has not been used to apply a coating over an already glazed, and fired, ceramic surface. It was previously considered that a dipped coating material would simply drain off the highly smooth glazed surface.

We have overcome this perceived difficulty in a number of ways. Firstly, by incorporating an adhesion promoter in the coating material, sufficient tenacity for the glazed surface is achieved. Typically the adhesion promoter is present in the range 0.1% to 10% by weight of the coating material mixture. A preferred range is 1.5 to 5% by weight of adhesion promoter.

An example of an adhesion promoter has been given above. Alternative adhesion promoters may be selected by the material specialist. It should be noted that extensive trails are generally necessary in this field of technology. This is because the appearance of a coated finish is highly dependent on the precise nature of the coating material and how that coating material is applied. To be of any value, the finished product must appear flawless to the naked eye.

The problem of adhesion of a dipped coating has also been overcome by moving straight from the dipping stage to the curing stage. That is to say, by not giving the dipped finish time to move over the glazed surface. In addition, the tableware item may be rotated or inverted on its way to and/or during the curing phase.

In a third method the ceramic tableware items are pre-heated before the dipping stage. In that way, curing begins immediately the item is dipped into the coating material. Thus the molecular layer of dip in contact with the surface of the tableware item cures and becomes bonded to the ceramic surface. This fine layer provides a surface considerably more adhesive to the coating than the original glazed or glass surface.

Preferably the tableware item is heated to a temperature in the range of 50° C. to 220° C. More preferably the temperature range is 70° C. to 120° C.

We have also discovered that the above methods can be applied to glass items as well as pottery or porcelain ceramics. Thus, in the context of the present invention, the term “ceramic” has a very broad meaning. It includes glass, earthenware, clayware and bone china.

When applied in a dipping process, or when applied to glass items, the thermochromic pigment used in the first coating material can be in a variety of forms. It may be in the form of a paste or slurry, a water-based or solvent-based ink, or as a paint. This flexibility greatly extends the scope of the method.

It will be appreciated that various other modifications may be made without departing from the scope of the invention. Whilst it is generally preferred that the coatings should be applied to substantially the entire outer surface of the tableware item, the coatings could be applied by different techniques and perhaps only to cover part of the surface of an article to provide particular effects. Different spraying and/or curing conditions can be used etc., as are appropriate to particular material used. The technique, whilst ideally suited to decorating tableware, can be used on a wide range of articles.

Whilst endeavouring in the foregoing specification to draw attention to those features of the invention believed to be of particular importance, it should be understood that the Applicant claims protection in respect of any patentable feature or combination of features hereinbefore referred to and/or shown in the drawings whether or not particular emphasis has been placed thereon.

1. A method of decorating a ceramic article, said method comprising the steps of:
a) mixing a thermochromic pigment with a first coating material to form a first coating mixture;
b) applying the first coating mixture directly onto a part or substantially the whole outer surface of the tableware article;
c) once the first coating mixture is cured, applying a second coating material over the first coating mixture;
wherein the second coating material is substantially dishwasher proof.

2. A method according to claim 1, wherein the first coating mixture is applied to the ceramic article by a dipping process.

3. A method according to claim 1, wherein the second coating material is applied by a dipping process.

4. A method according to claim 1, wherein both the first coating mixture and the second coating material are applied by a dipping process.

5. A method according to claim 2, wherein the ceramic article is pre-heated immediately prior to the dipping stage.

6. A method according to claim 5, wherein the ceramic article is pre-heated to a temperature in the range 50° to 220° C.

7. A method according to claim 5, wherein the ceramic article is pre-heated to a temperature in the range 70° to 120° C.

8. A method according to claim 2, wherein the first coating mixture further comprises an adhesion promoter.

9. A method according to claim 8, wherein the proportion of adhesion promoter in the first coating mixture is within the range 0.1% to 10% by weight, and more preferably in the range of 1.5% to 5% by weight.

10. A method according to claim 1, wherein the ceramic article is an article of glassware.

11. A method according to claim 1, wherein the ceramic article is an article of glazed tableware.

12. A method according to claim 1, wherein the first coating material is substantially transparent.

13. A method according to claim 1, wherein the second coating material is substantially transparent.

14. A method according to claim 1, wherein the first and/or second coating materials comprise lacquers.

15. A method according to claim 14, wherein the first coating material comprises a water based lacquer.

16. A method according to claim 14, wherein the second coating material comprises a two-part epoxy fortified acrylic resin, including an activator and a thinner.

17. A method according to claim 1, wherein the thermochromic pigment comprises a thermochromic ink.

18. A method according to claim 1, wherein the proportion of thermochromic pigment in the mixture is within the range 5% to 35% by weight.

19. A method according to claim 1, wherein the first coating mixture and/or second coating material are cured following application onto the article.

20. A method according to claim 19, wherein the curing commences with a period in an infra-red shortwave drier followed by a heat cure.

21. A method according to claim 1, wherein the curing includes a heat cure comprising a lower temperature first period, followed by a higher temperature second period.

22. A method according to claim 21, wherein for the first coating mixture, the first period lasts between one and two minutes at 35° C. to 65° C., with the second period lasting eight to twelve minutes at 140° C. to 220° C.

23. A method according to claim 1, wherein for the second coating material the first period lasts between eight and twelve minutes at 35° C. to 65° C., with the second period lasting twenty five to thirty minutes at 110° C. to 165° C.

24. A method according to claim 1, wherein a decoration is provided on the article beneath the mixture such that when the thermochromic ink is at least translucent, said decoration is visible.

25. A method according to claim 1, wherein the first coating mixture comprises a plurality of thermochromic inks with different colour change temperatures.

26. A method according to claim 25, wherein the inks are different colours.

27. A method according to claim 1, where said second coating material is applied to the article by spraying.

28. A method according to claim 27, wherein the first coating mixture and/or second coating material are applied to the article by electrostatic spraying.

29. A method according to claim 28, wherein an electrostatic thinner is added to the mixture and/or second coating prior to spraying.

30. A method according to claim 28, wherein the first coating mixture and the second coating material are applied to a thickness of between 12 and 24 microns.

31. A method according to claim 1, wherein an electrostatic thinner is added to at least one of said first coating mixture and said second coating material prior to spraying.

32. A method according to claim 1, wherein said method comprises a further step whereby a decoration is applied onto the second coating material, once cured, by means of a dye sublimation process.

33. A decorated ceramic article, comprising:
a) a ceramic article,
b) a thermochromic pigment mixed with a first coating material forming a first coating mixture on said ceramic article, said first coating mixture applied directly onto a part or substantially the whole outer surface of the ceramic article; and
c) a second coating material applied over the first coating mixture after the first coating mixture is cured, wherein the second coating material is substantially dishwasher proof.
